(19) United States
(12) Patent Application Publication
(10) Pub. No.: US 2011/0030747 A1
(43) Pub. Date: Feb. 10, 2011

(54) Seat assembly for releasable attachment between crutches

(76) Inventor: Loran L. Lee, Lake Isabella, CA (US)

Correspondence Address: KLEIN, DENATALE, GOLDNER, COOPER et. al., P.O. BOX 11172, BAKERSFIELD, CA, 93389-1172, US

(21) Appl. No.: 12/462,685

(22) Filed: Aug. 6, 2009

(51) Int. Cl. A61H 3/02; A45B 5/00; A47C 4/00

(52) U.S. Cl. 135/66; 297/118

(57) ABSTRACT

A seat assembly for releasable attachment between crutches comprising crutches, the crutches comprising a center support and a pair of outer support members. The outer support members further comprise a plurality of opposed hand grip retention apertures. A seat support comprises a seat support pin received in a hand grip retention aperture of the first crutch, a support body engaged by the seat support pin, and a seat engagement pin that engages one end of the seat is attached to the first crutch. A seat retention pin received in a hand grip retention aperture of the second crutch engages the other end of the seat when the seat is deployed. There may be a brace attached to the seat bottom side and the first crutch.

### CROSS-REFERENCE TO RELATED APPLICATION

U.S. Provisional Application No. 61/188,054 for this invention was filed on Aug. 5, 2008, for which application this inventor claims domestic priority.

### BACKGROUND OF THE INVENTION

This invention relates to accessory equipment for crutches, and more particularly to a seat assembly pivotally attached to a first crutch and releasably attached to a second crutch. The seat assembly can be engaged by the user to provide seating when necessary or convenient for the user.

Crutches are widely used temporarily during recovery from surgeries or illness, as well as long term use to improve mobility for the temporarily or permanently disabled. The use of crutches for aiding in movement allows a person to venture further than they would be able to if they were unaided, and the person will often find they are far from a convenient place to stop and rest. The use of the present device will allow the person to stop and rest when they are tired rather than continue onward and perhaps become totally exhausted.

### SUMMARY OF THE DEVICE

The disclosed device comprises a seat assembly pivotally attached to a first crutch and releasably attached to a second crutch. The seat pivots upon a first mounting point disposed upon the first crutch, and engages a second mounting point disposed upon the second crutch. The seat assembly is disposed against the first crutch when not in use.

The device uses the existing holes in the crutch body to support and provide an engagement surface for the seat. The seat length and width can be selected by the user to fit their needs and provide a comfortable seating area.

The seat is attached to a seat support that comprises a seat support pin received in a hand grip retention aperture of the first crutch, a support body engaged by the seat support pin, and a seat engagement pin that engages apertures within the seat and the support body. The support body and seat second end transfer the weight from the seat to the outer support members and then to the center support. The support body would preferably be formed from a light-weight but strong substance, so that the user is adequately supported but does not have to carry excess weight

### BRIEF DESCRIPTION OF THE DRAWINGS

FIG. 1 is a perspective view of the seat assembly for releasable attachment between crutches, showing the seat in the attached position.

FIG. 2 is a side view of the seat assembly for releasable attachment between crutches, also showing the seat in the attached position.

FIG. 3 is a side view of the seat assembly for releasable attachment between crutches, showing the seat in the deployed position, and showing the attachment point for attaching the seat to the second crutch.

FIG. 4 is a perspective view of the seat assembly for releasable attachment between crutches, showing the seat in the non-deployed position.

FIG. 5 is a bottom view of the seat assembly for releasable attachment between crutches, showing the seat in the deployed position, and showing the support arm.

FIG. 6 is a perspective view of the seat assembly for releasable attachment between crutches, showing the seat in the non-deployed position, and showing the seat attachment to the first crutch.

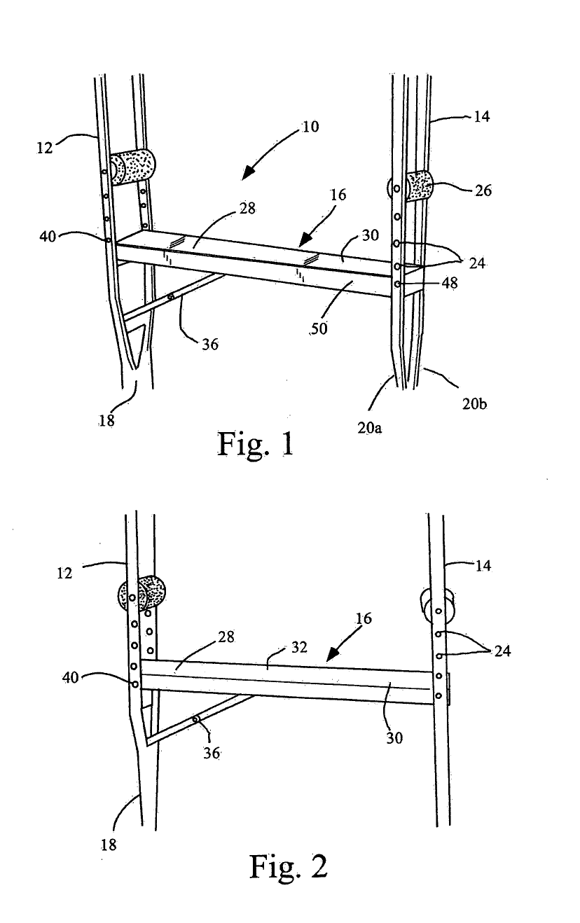

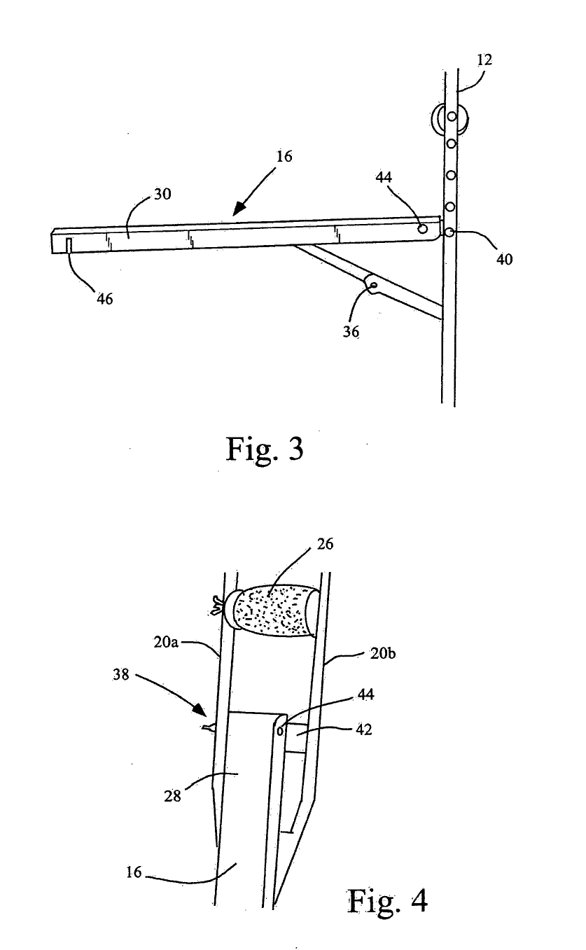

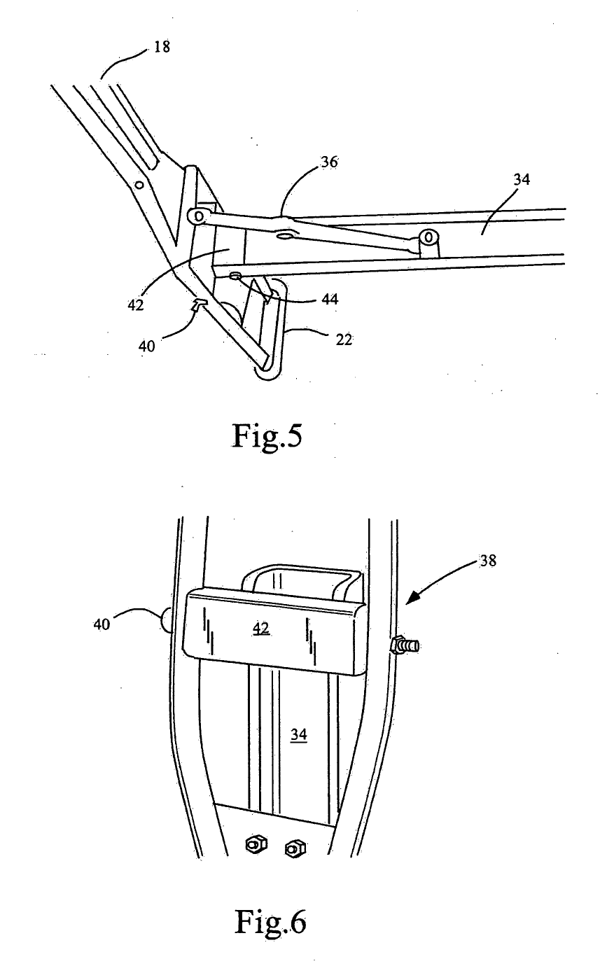

### DETAILED DESCRIPTION OF THE INVENTION

With reference to the Figures, the disclosed device will be described in detail. The device comprises a seat assembly for releasable attachment between crutches 10 comprising pair of crutches 12, 14 which engage and support a seat 16. The crutches 12, 14 are of conventional construction and comprise a center support 18 that contacts the floor, and is usually covered at the contact point with the floor by a rubber cap or similar gripping material. Connected to the center support 18 are a pair of outer support members 20a, 20b that bow outwards from their connection to the center support 18, and terminate in a upper piece 22 that joins the outer support members 20a, 20b and fits under the user's armpit. The outer support members 20a, 20b further comprise a plurality of opposed hand grip retention apertures 24 for retention of the hand grips 26. The plurality of apertures 24 allow for adjustment of the hand grips 26 according to the height of the user, and provide spaces from which the seat assembly 10 may be mounted and attached.

The seat 16 comprises a first end 28 and a second opposed end 30, and a top side 32 where the user sits, and a bottom side 34, which may be used for attachment of a brace 36. The brace 36 may be of the locking variety such that the user needs to physically disengage the locking mechanism before pivoting the seat 16 back to the non-deployed position. A seat support 38 comprises a seat support pin 40 received in a hand grip retention aperture 24 of the first crutch 12, a support body 42 engaged by the seat support pin 40, and a seat engagement pin 44 that engages apertures within the seat 16 and the support body 42. The brace 36 may be attached to the first crutch 12 beneath the support body 42. The seat 16 engages and pivots upon the seat engagement pin 44 when the seat 16 is moved from the deployed position for sitting to the non-deployed position for walking, as well as during the reverse. During use, the support body 42 transfers the weight from the seat first end 28 to the outer support members 20a, 20b and then to the center support 18. The support body 42 is sized to fit within the width of the outer members 20a, 20b of conventional crutches, and for example, a smaller support body 42 would be used for children's crutches as the distance between the outer support members 20a, 20b would be closer. The seat 16, as well as the seat support pin 40 and seat engagement pin 44 would also be correspondingly smaller.

The seat second end 30 comprises a slot 46 for engagement with the seat retention pin 48 placed within the apertures 24 of the second crutch 14. When the seat 16 is deployed for use in the sitting position, the weight of the user is transferred from the seat second end 30 to the outer supports 20a, 20b, and then onto the center supports 18 through the seat support pin 40 and the seat retention pin 48. The seat assembly for releasable attachment between crutches 10 would likely be capable of supporting weights of users up to and including persons weighing 300 pounds.

The top of the seat 32 may further comprise a pair of depending walls 50, which may comprise an opposed pair of apertures which may receive the seat engagement pin 44, and thus support the seat 16 through a pin placement that traverses the seat from side to side. The seat engagement pin 44 engages and retains the support body 42, both when the seat 16 is deployed and when the seat 16 is disengaged.

A seat retention pin 48 received in a hand grip retention aperture 24 of the second crutch 14 is used to engage and support the second end 30 of the seat 16 through engagement of the slot 46 and the seat retention pin 48. The seat retention pin 48, the seat support pin 42 and the seat engagement pin 44 may comprise bolt and nut assemblies.

In use the user would lift the seat, which would pivot upon the seat support pin and place the slot of the seat over the seat retention pin. If so equipped, the user would also engage the brace when the seat is deployed, to provide additional support for the user. When finished sitting, the user would simply reverse the process and disengage the slot from the seat retention pin, and lower the seat by pivoting the seat downwards to beside the first crutch.

While the above is a description of various embodiments of the present invention, further modifications may be employed without departing from the spirit and scope of the present invention. Thus the scope of the invention should not be limited according to these factors, but according to the following appended claims.

I claim

1. A seat assembly for releasable attachment between a pair of crutches comprising:
a first crutch and a second crutch, the crutches comprising a center support and a pair of outer support members, the outer support members further comprising a plurality of opposed pairs of hand grip retention apertures;
a seat support comprising a seat support pin received in an opposed pair of the hand grip retention apertures of the first crutch, a support body engaged by the seat support pin, and a seat engagement pin retained within the support body;
a seat retention pin received in an opposed pair of hand grip retention apertures of the second crutch; and
a seat comprising a first end and a second opposed end and a top side and a bottom side, wherein the seat first end engages with and pivots upon the seat engagement pin, and the seat second end comprises a slot for engagement with the seat retention pin.

2. The seat assembly for releasable attachment between crutches of claim 1 wherein the seat retention pin comprises a bolt and nut.

3. The seat assembly for releasable attachment between crutches of claim 1 wherein the seat support pin comprises a bolt and nut.

4. The seat assembly for releasable attachment between crutches of claim 1 wherein the seat engagement pin comprises a bolt and nut.

5. The seat assembly for releasable attachment between crutches of claim 1 wherein the top of the seat further comprises a pair of depending walls.

6. The seat assembly for releasable attachment between crutches of claim 5 wherein the walls of the seat second end comprise an opposed pair of apertures which receive the seat engagement pin.

7. The seat assembly for releasable attachment between crutches of claim 1 further comprising a brace attached to the seat bottom side and the first crutch.

8. The seat assembly for releasable attachment between crutches of claim 7 wherein the brace is a locking brace.

9. A seat assembly for releasable attachment between crutches for use with a pair of crutches, the crutches comprising a first crutch and a second crutch having a plurality of opposed hand grip retention apertures, the seating system comprising:
a seat support comprising a seat support pin received in an opposed pair of hand grip retention apertures of the first crutch, wherein the seat retention pin comprises a bolt and nut, a support body engaged by the seat support pin, and a seat engagement pin retained within the support body wherein the seat engagement pin comprises a bolt and nut;
a seat retention pin received in an opposed pair of hand grip retention apertures of the second crutch, wherein the seat retention pin comprises a bolt and nut; and
a seat comprising a first end and a second opposed end, and a top side and a bottom side, wherein the seat first end engages with and pivots upon the seat engagement pin, and the seat second end comprises a slot for engagement with the seat retention pin.

10. The seat assembly for releasable attachment between crutches of claim 9 wherein the top of the seat further comprises a pair of depending walls.

11. The seat assembly for releasable attachment between crutches of claim 10 wherein the walls of the seat second end comprise an opposed pair of apertures which receive the seat engagement pin.

12. The seat assembly for releasable attachment between crutches of claim 9 further comprising a brace attached to the seat bottom side and the first crutch.

13. The seat assembly for releasable attachment between crutches of claim 12 wherein the brace is a locking brace.

14. A seat assembly for releasable attachment between crutches for use with a traditional set of crutches, wherein the crutches comprise a center support and a pair of outer support members, the outer support members further comprising a plurality of opposed hand grip retention apertures, the seating system comprising:
a seat support comprising a seat support pin received in an opposed pair of hand grip retention apertures of a first crutch, a support body engaged by the seat support pin, and a seat engagement pin retained within the support body;
a seat retention pin received in an opposed pair of hand grip retention apertures of a second crutch;
a seat comprising a first end and a second opposed end and a top side, a bottom side, and a pair of opposed walls depending from the top side, wherein the seat first end engages with and pivots upon the seat engagement pin, and the seat second end comprises a slot for engagement with the seat retention pin; and
a brace attached to the seat bottom side and the first crutch.

15. The seat assembly for releasable attachment between crutches of claim 14 wherein the seat retention pin comprises a bolt and nut.

16. The seat assembly for releasable attachment between crutches of claim 14 wherein the seat support pin comprises a bolt and nut.

17. The seat assembly for releasable attachment between crutches of claim 14 wherein the seat engagement pin comprises a bolt and nut.

18. The seat assembly for releasable attachment between crutches of claim 14 wherein the walls of the seat second end comprise an opposed pair of apertures which receive the seat engagement pin.

19. The seat assembly for releasable attachment between crutches of claim 14 wherein the brace is a locking brace.
